(19) United States
(12) Patent Application Publication
(10) Pub. No.: US 2015/0066611 A1
(43) Pub. Date: Mar. 5, 2015

(54) Consolidated Merchant Programs System

(71) Applicants: Wee Ping Chua, SINGAPORE (SG); Mei Yea Tia, Singapore (SG)

(72) Inventors: Wee Ping Chua, SINGAPORE (SG); Mei Yea Tia, Singapore (SG)

(21) Appl. No.: 14/383,547

(22) PCT Filed: Apr. 27, 2012
(86) PCT No.: PCT/SG12/00151

§ 371 Date: Nov. 11, 2014

(30) Foreign Application Priority Data
Mar. 8, 2012 (SG) 201201767-9

(51) Int. Cl. G06Q 30/02; H04L 29/08

(52) U.S. Cl. CPC G06Q 30/0229; H04L 67/10
USPC 705/14.3

(57) ABSTRACT

The present invention discloses a consolidated merchant programs system comprising at least a merchant node operated by a merchant; at least a mobile consumer node operated by a consumer; a server having a user interface to provide an online platform for the merchant to launch one or more merchant programs through the merchant node; a merchant code generated by the server based on the merchant program; a primary consumer code generated by the server and assigned to the consumer as an identity of the consumer; the primary consumer code is downloaded to the consumer node upon signing up for a consumer account on the system; and a secondary consumer code containing data of the merchant program enrolled by the consumer and the identity of the consumer; the secondary consumer code is generated through capturing the primary consumer code by the merchant node and sending the primary consumer code and merchant code by the merchant node to the server for processing to generate the secondary consumer code or through capturing the merchant code by the consumer node and sending the merchant code and primary consumer code to the server by the consumer node for processing to generate the secondary consumer code; wherein the secondary consumer code is downloaded to the consumer node upon approval of enrollment of the consumer in the merchant program for participating in a consumer activity of the merchant program.

### FIELD OF INVENTION

The present invention relates to a consolidated merchant programs system and a method of enrolling in a merchant program of the system. In more particular, the system provides an online platform for participation of consumers in a variety of merchant programs launched by different merchants.

### BACKGROUND OF THE INVENTION

Structured marketing strategies are necessary for merchants to promote sales and encourage return business in a competitive business environment. Loyalty, membership and reward programs are common examples of marketing efforts carried out by merchants to establish a high level of consumer retention, revenue and profitability, leading to increased consumer satisfaction. With these programs launched by merchants, consumers can be rewarded for their patronage by being offered discounts or points that can be redeemed for merchandise, gift cards, cash back and vacations.

To identify participants of the merchant programs, consumers are usually given cards of the program they enrolled in which the cards are presented to the merchant to record every purchasing activity to accumulate points or obtain discounts. Magnetic strips, chips or barcodes could be found on the cards for easy scanning to record the purchase activity. These cards also enable tracking of consumer data which are stored in a database. Other tools for identifying a member of a program and recording purchasing activity include key fobs. However, such tools are cumbersome and burdensome for consumer enrolled in a large variety of merchant programs to carry around with them, which will in turn bring adverse effect to the business of the merchants.

In addition to that, it is less environmentally friendly to use cards and key fobs which are typically made of plastics. Registration to participate in the merchant programs are conventionally conducted through filling in details of consumers on forms which is inconvenient for both the consumer and merchant, especially when it is carried out at the point of sale where other consumers are waiting at a long queue. Also, the increasingly prevalence of various programs with different schemes launched by merchants could easily cause confusion amongst consumers and results in the ineffectiveness and failure of delivery of these programs to engage customers.

Approaches to omit the utilization of multiple cards and key fobs include adopting a single device to manage multiple concurrent programs by a consumer which is described in U.S. Patent No. 20100042517 that discloses a method of providing a universal access to loyalty programs and financial accounts. A universal loyalty program account and financial account device are initialized and associated with at least one loyalty program and/or financial account. The loyalty program or financial account could be accessed at a customer facing device through the universal access program. Examples of the device are electronic key fob, cellular device and presentation instrument with a magnetic strip, bar code or radio frequency chip. The device could be configured to display a barcode associated with a loyalty program that can be swiped or read at the point of sale.

Another prior art, U.S. Patent No. 2010094699 similarly adopts a digital system in place of multiple cards or key fobs for consumers to participate in the programs launched by different merchants. The consolidated consumer rewards system as revealed in this patent comprises a consumer rewards platform for maintaining multiple consumer numbers used to enroll multiple consumer rewards programs and account for all purchasing activity that is connected to a plurality of merchant-consumer rewards platform and a unique consumer number assigned to each consumer for enrollment in the consumer rewards system which could be printed, bar coded or programmed onto a physical medium or device such as a card, barcode or radio frequency identification tag. The consumer rewards platform is connected to a card vendor system to facilitate payment transaction. Unlike the universal access system disclosed in U.S. Patent No. 20100042517 which does not involve the participation of merchants, U.S. Patent No. 2010094699 provides a merchant portal network connection for merchants to access the consumer rewards platform to input information pertaining to the consumer rewards program.

Whilst merchants are involved in the system described in U.S. Patent No. 2010094699, there is a limited usability of the systems in the abovementioned prior arts for the merchant and consumer in which participation in a merchant program could only be conducted with the use of the unique code assigned to each consumer which is displayed on a mobile device or medium of the consumer. One of the major features of the present invention enables expansion of the usability of a consolidated merchant programs system so that enrollment to a merchant program or participation in a merchant program is not constrained to a single way which is through reading the consumer code.

The present invention shall introduce a digital system that consolidates various programs launched by different merchants with just a universal access to bring more convenience to users. An organized and user friendly system would be able to bring positive effect on repeat purchase intentions of consumers. Also, the present invention encourages more interaction between the merchant and consumer to strengthen the relationship between the two.

### SUMMARY OF INVENTION

The main aspect of the present invention is to provide a mobile and digital system that consolidates various programs launched by different merchants, allowing consumers to maintain a single device to gain access or participate in all the programs enrolled.

Another aspect of the present invention is to provide a consolidated merchant programs system that is user friendly by enabling different ways to gain access or participate in the merchant programs.

Still another aspect of the present invention is to provide an organized, hassle free and eco-friendly system for carrying out programs launched by merchants that reduce the use of physical means such as cards and key fobs which carry the identification of the participant of the programs.

Yet another aspect of the present invention is to provide a consolidated merchant programs system that encourages interaction between the merchant and consumer.

Also another aspect of the present invention is to provide a consolidated merchant programs system that enables instant participation in the merchant programs by the merchant and the consumer.

Again another aspect of the present invention is to provide a consolidated merchant programs system that eliminates, reduces or replaces the need of consumers to fill in paper or online forms and merchants to manually consolidate data of consumers.

At least one of the preceding aspects is met, in whole or in part, by the present invention, in which the embodiment of the present invention describes a consolidated merchant programs system comprising at least a merchant node operated by a merchant; at least a mobile consumer node operated by a consumer; a server having a user interface to provide an online platform for the merchant to launch one or more merchant programs through the merchant node; a merchant code generated by the server based on the merchant program; a primary consumer code generated by the server and assigned to the consumer as an identity of the consumer; the primary consumer code is downloaded to the consumer node upon signing up for a consumer account on the system; and a secondary consumer code containing data of the merchant program enrolled by the consumer and the identity of the consumer; the secondary consumer code is generated through capturing the primary consumer code by the merchant node and sending the primary consumer code and merchant code by the merchant node to the server for processing to generate the secondary consumer code or through capturing the merchant code by the consumer node and sending the merchant code and primary consumer code to the server by the consumer node for processing to generate the secondary consumer code; wherein the secondary consumer code is downloaded to the consumer node upon approval of enrollment of the consumer in the merchant program for participating in a consumer activity of the merchant program.

The present invention also discloses a method of enrolling a consumer in a merchant program through a consolidated merchant programs system comprising the steps of providing an online platform as a user interface communicating with a server; providing a consumer capable of communicating with the server by a mobile consumer node storing a primary consumer code based on an identity of the consumer; launching the merchant program by a merchant through a merchant node via the online platform; generating a merchant code based on the merchant program (107); publishing the merchant code and information of the merchant program digitally and/or physically; and enrolling the consumer in the merchant program (109) either through capturing the primary consumer code by the merchant node and sending the primary consumer code and merchant code by the merchant node to the server for processing to generate a secondary consumer code or through capturing the merchant code and sending the merchant code and primary consumer code by the consumer node to the server for processing to generate the secondary consumer code; wherein the secondary consumer code generated contains data of the identity of the consumer and merchant program enrolled; the secondary consumer code is downloaded to the consumer node (111) upon enrolling in the merchant program.

### BRIEF DESCRIPTION OF THE DRAWINGS

FIG. 1 is a flow chart summarizing the process of signing up for a merchant and consumer account on the consolidated merchant programs system, enrolling in a merchant program and participating in a merchant program.

FIG. 2 is a flow chart showing the process of how merchants could sign up for a merchant account on the consolidated merchant programs system.

FIG. 3 is a flow chart showing the process of how merchants could launch programs on the online platform of the consolidated merchant programs system.

FIG. 4 is a flow chart showing the process of how consumers could sign up for a consumer account on the consolidated merchant programs system.

FIG. 5 is a flow chart showing the process of how consumers could enroll in a program of the consolidated merchant programs system launched by a merchant.

FIG. 6 is a flow chart showing the process of how consumers could participate in a merchant program of the consolidated merchant programs system.

FIG. 7 is a flow chart showing the process of how consumers could convert their existing physical cards to consumer codes which serve as mobile cards displayed on a mobile consumer node.

### DETAILED DESCRIPTION OF THE INVENTION

The present invention discloses a consolidated merchant programs system comprising at least a merchant node operated by a merchant; at least a mobile consumer node operated by a consumer; a server having a user interface to provide an online platform for the merchant to launch one or more merchant programs through the merchant node; a merchant code generated by the server based on the merchant program; a primary consumer code generated by the server and assigned to the consumer as an identity of the consumer; the primary consumer code is downloaded to the consumer node upon signing up for a consumer account on the system; and a secondary consumer code containing data of the merchant program enrolled by the consumer and the identity of the consumer; the secondary consumer code is generated through capturing the primary consumer code by the merchant node and sending the primary consumer code and merchant code by the merchant node to the server for processing to generate the secondary consumer code or through capturing the merchant code by the consumer node and sending the merchant code and primary consumer code to the server by the consumer node for processing to generate the secondary consumer code; wherein the secondary consumer code is downloaded to the consumer node upon approval of enrollment of the consumer in the merchant program for participating in a consumer activity of the merchant program.

The consumer activity is participated through capturing the secondary consumer code by the merchant node and sending the secondary consumer code and merchant code to the server by the merchant node for processing or through capturing the merchant code by the consumer node and sending the merchant code and secondary consumer code to the server by the consumer node for processing. The server stores data of the codes and activities run by the consumer and merchant. The consumer activity includes purchasing activities and participation in any merchant programs by the consumer whereas the merchant activity includes activities of managing the merchant programs conducted by the merchant.

It should be noted that the term ‘merchant’ used throughout this specification includes retailers, organizations, government bodies, financial institutions, hospitals, schools and any other business or non-profit entities whereas ‘consumer’ includes an individual or organization that acquires goods or services from the merchant. The term ‘merchant node’ is used to indicate devices used by the merchants such as computer, phone, tablets, PDAs or merchant stations such as kiosk or terminals for accessing the online platform to launch and administer the merchant programs as well as capture consumer codes. On the other hand, the term ‘consumer node’ is used to indicate devices which are preferably portable such as phones, tablets and PDAs used by the consumers to capture the merchant codes and access the online platform. The number of merchant nodes possessed by a merchant and consumer nodes possessed by a consumer are not limited. The merchant could utilize the same or different merchant nodes to launch the merchant program and capture consumer codes. Similarly, the consumer could employ the same or different consumer nodes to capture the merchant code and access the online platform.

In a situation where there are two or more merchant programs launched by the same merchant, the consumer should notify the merchant which merchant program he intends to enroll to avoid confusion. The merchant node is configured to specify the name of the merchant program that the consumer intended to enroll prior to or after capturing the primary consumer code.

With the system enabling various merchant programs to be consolidated, an organized online platform could be provided to different merchants to launch and administer their programs, yet bringing convenience to consumers whereby they could access and manage the merchant programs enrolled through a universal access. A variety of merchant programs could be launched on the platform and are not limited to a discount program, stamp card program, points reward program, rebate program, reward redemption program, membership enrollment program, membership renewal program, lucky draw program, ticketing program, coupon program, voucher program, promotion program, subscription program, activity registration program, voting program and feedback program. Similar to a punch card program, the stamp card program rewards the consumer by giving extra free products after collection of a certain number of purchases recorded in the system. The difference between the point reward program and the stamp card program is that the point reward programs accumulate points rather than the number of purchases. Merchandise, travel, cash back or discounts could be redeemed after accumulation of a number of points from the reward redemption program. On the other hand, the rebate program allows reduction, return, or refund on what has already been paid after a collection of an amount of purchases.

With the membership program being launched through the present invention, membership renewal could be conducted via the online platform remotely where consumers can be reminded about the membership expiration date and make payment through the gateway provided by the system or through other payment sources. Also, membership enrolment could also be done via the present invention. Besides that, the system is capable of auto-generating unique lucky draw tickets numbers for each lucky draw tickets issued and enables tracking of the ticket. Consumers do not have to keep multiple physical lucky draw tickets. Other than that, purchasing of tickets to events and subscription of promotion and newsletter could be done through the online platform or by capturing of the merchant code of the event organizer or through capturing the primary consumer code by the event organizer. On the other hand, the coupons or vouchers program allows consumer to either purchase coupons or vouchers or receive free coupons or vouchers as promotional gifts from the merchant if the consumer has fulfilled certain requirements set by the merchant.

Voting or rating of the service or product could be done too by the consumer through the online platform using the mobile consumer node. Feedback could also be given to the merchant without the need to fill in feedback forms by just capturing the merchant code and provide instant feedback with the option for consumers to choose whether to disclose their identity. Registration for activities such as to become customer or member of an organization as well as registration to take part in events, seminars or exhibitions could also be conducted with the use of the present invention where physical cards to identify the consumer as a member of the activity are not required. The utilization of the present invention could save consumers from hassles of having to fill up paper or online forms whenever they register for an activity. By capturing the merchant or consumer codes, the registration process could be accelerated without having to waste time filing up the forms. Accuracy of data could also be assured as human errors due to misinterpretation of hand written words or carelessness could be avoided. The system also facilitates the organization of the data received from the consumers. Besides the programs mentioned above, merchants could also set up customized programs to improve their services to consumers.

Reduction or elimination of the need to fill up online or paper forms are also applied to other merchant programs besides the activity registration program as mentioned above. The consumer information provided by the consumers when they signed up for a consumer account could be transferred to be used in the merchant program. Should more information are required, an alert requesting for additional information will be sent to the consumer. The additional information could be consolidated with the existing information saved in the server and sent to the merchant. Once the merchant acquires all the information needed from the consumer, the secondary consumer code will be issued to the consumer.

Unique identifiers to look up additional information about the consumer or merchant are stored in the merchant and consumer codes which could be in the form of any one or combination of a barcode, matrix code or a chip that enables data to be transmitted via radio frequency. The barcodes and matrix codes are preferably in one dimension or two dimensions. A few examples of the codes are the Quick Response (QR) code, Aztec code, data matrix code and Near Field Communication (NFC) chip. The merchant code contains data of a specific merchant program. The primary consumer code contains identity data of a consumer user of the system whereas the secondary consumer code is an identity of the consumer user as a member of a certain merchant program.

To identify the consumer and merchant, the consumer is assigned the primary consumer code whereas the merchant receives a merchant identity once they signed up for an account on the system via the online platform. While the merchant code generated for each merchant program could be displayed on the internet or printed out to be pasted at any locations that can be easily spotted by consumers to capture the merchant code, the primary and secondary consumer codes are downloaded to the mobile consumer node to be presented to the merchant for the merchant to capture the consumer code. Capturing of the codes could be done by a camera, a scanner or a sensor. Therefore, the merchant node for capturing consumer codes which is usually located at the point of sale is equipped with any one or combination of a camera, scanner or sensor to read the consumer code. The merchant node for capturing consumer codes is implemented with a program having code capturing and reading functions that is connected to the online platform and either one or combination of the camera, scanner or sensor. However, it is not required for a merchant node used solely for accessing the online platform and not for capturing consumer codes to be equipped with a camera, scanner or sensor as well as implemented with a program having code capturing and reading functions.

Similarly, the mobile consumer node is also equipped with either one or combination of the camera, scanner or sensor to capture the codes. The camera or a scanner is necessary for capturing the codes whereby the codes are read by sweeping a small spot of light across the code through scanning or by taking digital images of the codes by a camera. As for codes in the form of a chip such as the Near Field Communication chip, the chip can be read by a device implemented with a Near Field Communication enabled sensor that generates a radio frequency field to establish a radio communication with the chip for transferring data of the codes. Data captured by both the consumer and merchant nodes are delivered to the server for processing.

The online platform is accessible through a mobile application and/or a web browser. It is preferable that the mobile consumer node is a smart phone. Other options of the mobile consumer node include computer such as a tablet, PDAs or any other electronic devices which could access the online platform through the mobile application and display the consumer codes that are downloaded to the consumer node. The mobile application is incorporated with code capturing and reading functions that is connected to the online platform and either one or combination of the camera, scanner or sensor. On the other hand, the merchant node is a station or a device which could be a computer, terminal or kiosk. It should be noted that the merchant node could be a portable device like the mobile consumer node which could also utilize the mobile application. Hence, there could be two types of mobile application, one for consumers and the other one for merchants to use. Main components of the consumer and merchant nodes include a display screen, processor, memory, operating system and a network interface. For location detecting purposes on the place of scanning which is normally the location of the purchasing activity, the consumer and merchant nodes could also comprise a location detector module like a global positioning system (GPS). Additional elements such as a message module to facilitate interaction between the merchant and consumer as well as a member application module for accelerating application of an account could be added to the consumer and merchant nodes.

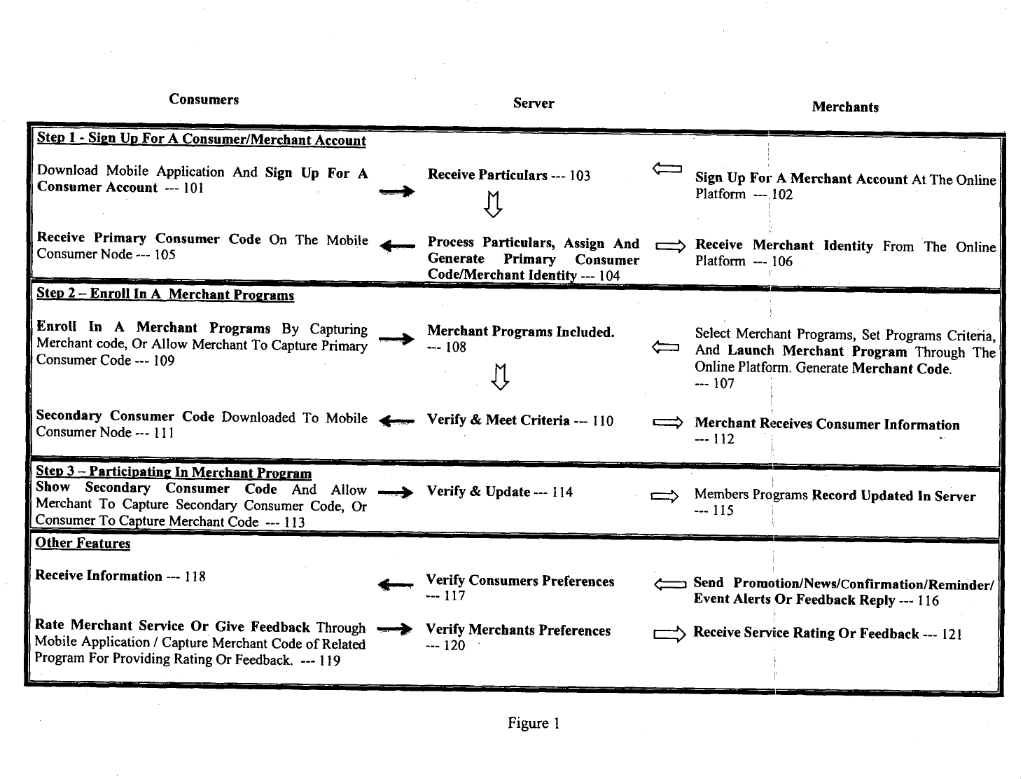

FIG. 1 summarizes the process of signing up for a merchant and consumer account on the consolidated merchant programs system, enrolling in a merchant program and participating in a merchant program. The method of enrolling a consumer in a merchant program through a consolidated merchant programs system comprising the steps of providing an online platform as a user interface communicating with a server; providing a consumer capable of communicating with the server by a mobile consumer node storing a primary consumer code based on an identity of the consumer; launching the merchant program by a merchant through a merchant node via the online platform; generating a merchant code based on the merchant program (107); publishing the merchant code and information of the merchant program digitally and/or physically; and enrolling the consumer in the merchant program (109) either through capturing the primary consumer code by the merchant node and sending the primary consumer code and merchant code by the merchant node to the server for processing to generate a secondary consumer code or through capturing the merchant code and sending the merchant code and primary consumer code by the consumer node to the server for processing to generate the secondary consumer code; wherein the secondary consumer code generated contains data of the identity of the consumer and merchant program enrolled; the secondary consumer code is downloaded to the consumer node (111) upon enrolling in the merchant program.

Participation in a customer activity for receiving any one or combination of benefits or services of the merchant program (113) is conducted either through capturing the secondary consumer code by the merchant node and sending the secondary consumer code and merchant code by the merchant node to the server for processing or through capturing the merchant code by the consumer node and sending the merchant code and secondary consumer code by the consumer node to the server for processing. Examples of benefits include any one or combination of privileges, discount, cash rebate, coupons, vouchers and rewards whereas the services could be any one or combination of stamps collection, points collection, membership enrolment, membership renewal, lucky draw, tickets purchasing, vouchers purchasing or redemption, coupons purchasing or redemption, subscription, activity registration, voting and giving feedback. Merchant activities carried out by merchants to administer the merchant programs are also recorded and saved to the server.

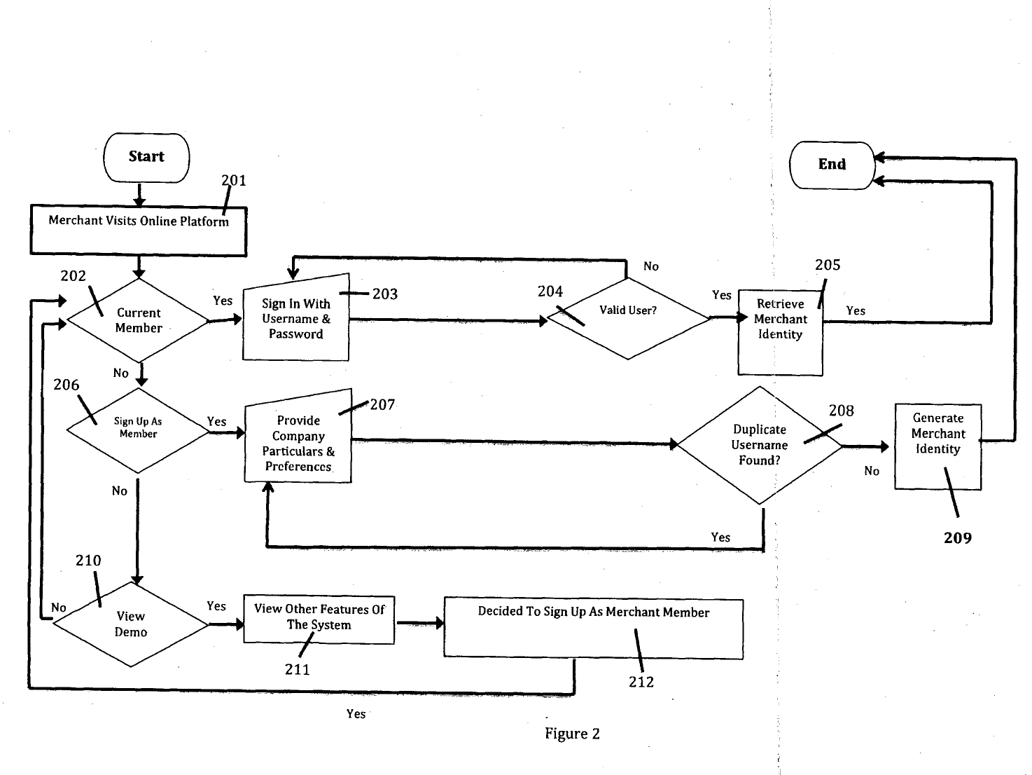

The online platform is accessible through a web portal using the merchant and consumer node. For use on portable devices such as smartphones and tablets, the mobile application is developed to access the online platform, capture the merchant and/or consumer code and present the codes that are downloaded to the mobile consumer node or merchant node. Information of the merchant program is published on the online platform. Prior to launching any merchant programs for consumers to enrol in, both merchant and consumer are required to sign up for an account. Consumers can sign up for a consumer account upon downloading the consumer mobile application (101) while the merchant can sign up for a merchant account through the online platform from a web browser. Else, the merchant could also sign up for the merchant account upon downloading a merchant mobile application (102). Details on how merchants can sign up for an account are described in the flow chart of FIG. 2. Visitors of the online platform (201) are requested for a username and password (202). Existing users are able to retrieve their personal merchant identities (205) after logging into the platform (203) upon being verified as a valid member of the system (204) after inputting their usernames and passwords. A new merchant member, on the other hand signs up for a merchant account (206) by providing particulars of his company and his preferences (207). A merchant identity is assigned to the new merchant member (209) upon successful registration. The new merchant member is required to enter a username which has not been registered to successfully sign up for an account (208). Else, the visitor could choose to view the demo of the system (210) to see the features of the system (211) before deciding to sign up for an account (212).

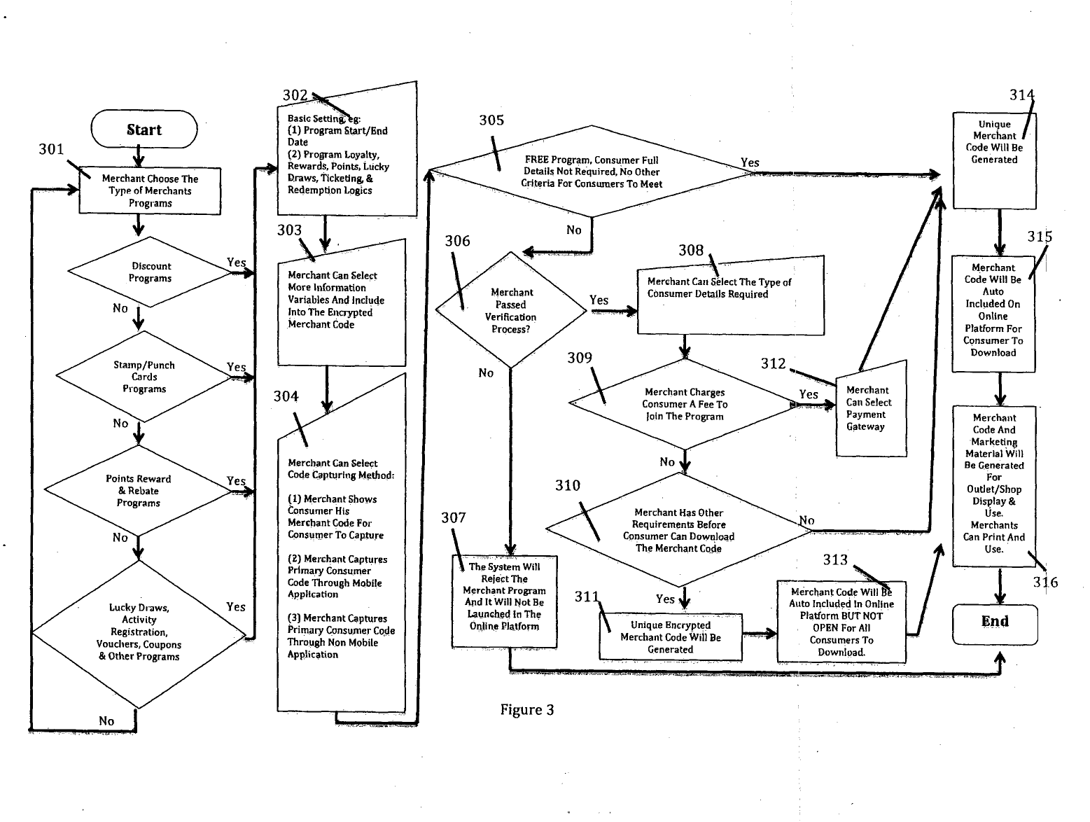

FIG. 3 depicts the process of how merchants could launch programs on the online platform of the consolidated merchant programs system. A list of merchant programs is available for selection. Once a program is chosen (301), the merchant is allowed to configure the settings of the program (302), for instance the start and end dates of the program. Information variables such as the shop outlets and the staff who authorized the program can be selected to be encrypted into the merchant code (303) that will be generated for consumers to capture for enrolling in the program. The method of enrolling in the program can also be set by the merchant. Merchants can either let consumers to capture their merchant codes or merchants can capture the primary consumer code by the merchant node that is accessible to the online platform (304).

Program criteria for consumers to meet could also be configured. Merchants can select the types of consumer details required (308) if merchants passed the verification process (306). Participation fee could also be charged (309) with a preferred payment gateway selected by the merchant (312). Once all criteria are set, the merchant program code is generated (314) and will be published on the online platform automatically. The merchant programs could be opened to the public for downloading (315) or restricted for certain consumers who are eligible to join the program (313). The merchant codes and other marketing materials could also be generated to be used or displayed in the shops for promotion of the programs (316).

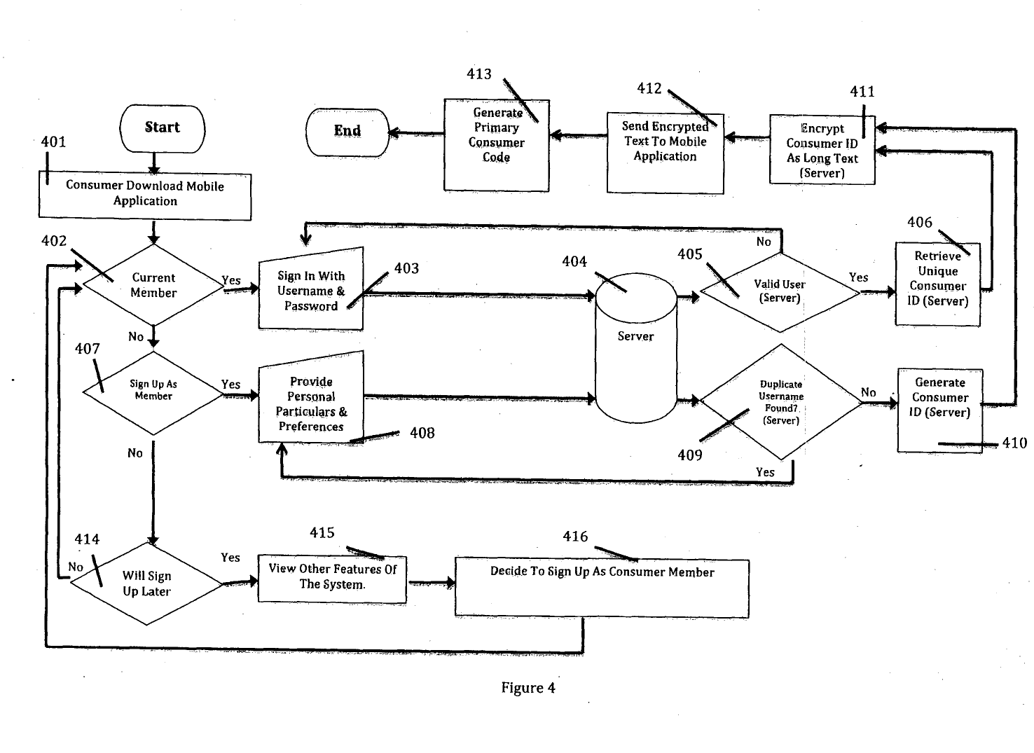

On the other hand, consumers can sign up for an account through the consumer mobile application downloaded to the mobile consumer node (401) as shown in FIG. 4. Existing consumer members (402) can just log into the online platform by their usernames and passwords (403) whereas new members can sign up (407) by providing their personal particulars and preferences (408). Username and password keyed in by existing users are referred to the data stored in the server (404) to check if they are valid users (405). The primary consumer code of the consumer is then retrieved (406) for use. As for the new members registering for an account (407), the username will be checked to avoid duplication of consumer members using the same usernames (409). A unique consumer identification is generated (410) by the server (404) upon successful registration. Once the unique consumer identification is retrieved (406) or generated (410), it is encrypted as a long text (411) and sent to the mobile application of the consumer. The primary consumer code is then generated (413) based on the encrypted text and downloaded to the mobile consumer node (412). Else, consumers who have not signed up for an account can view the features of the system (415) through the online portal as a guest.

There are several media where consumers can find out on-going merchant programs (501) such as the online platform which is accessible via the mobile applications and a web browser (502), the website of the merchant (503) and marketing media like advertisement and display of the merchant (504). Consumers could also be invited privately by the merchant to join the merchant programs (505). Fees might be incurred to participate in the merchant programs (507). Consumers will then be guided to the payment gateway to make the payment (513). Alternatively, consumers can choose to pay the merchant directly (513). As for free merchant programs (506), consumers can take part by capturing the merchant code which is displayed to the public or'the merchant could capture the primary consumer code (510).

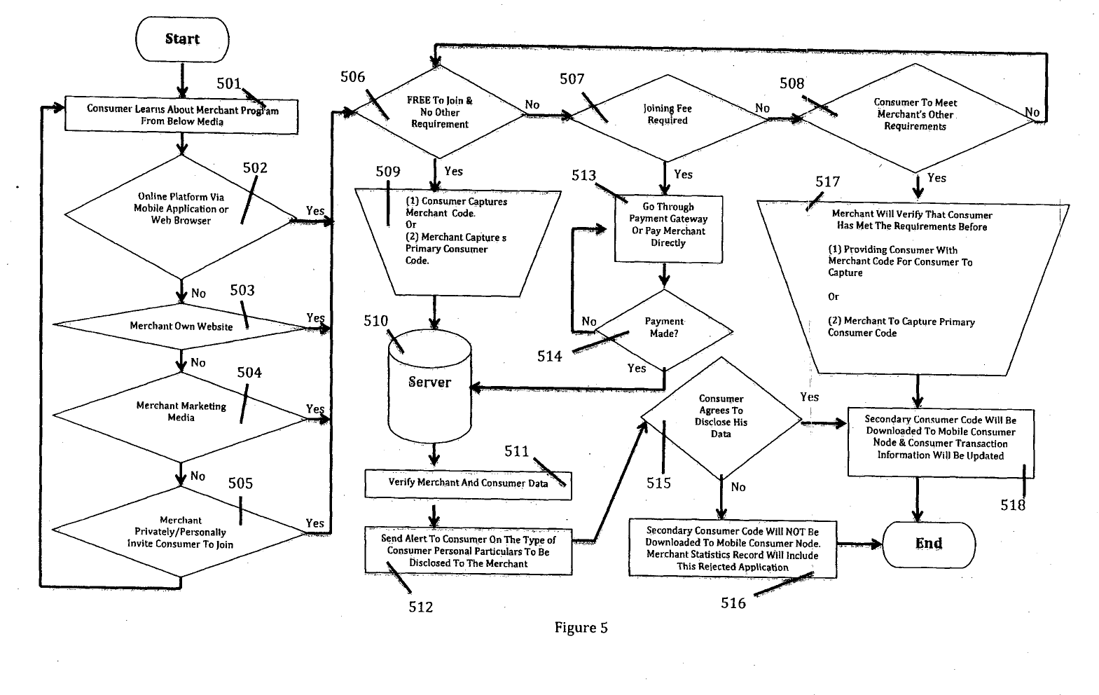

Once payment or capturing of the codes is successful, the server (510) verifies the merchant who launched the program and the data of the consumer (511). Consumers are in control on the type of particulars of themselves that could be disclosed to the merchant through alerts sent to the consumers (512). Besides that, consumers could also take part in the merchant programs if they meet certain requirements set by the merchant (508). For instance, a consumer would be eligible to enroll in a merchant program if the purchase he made exceeded the minimum purchase required to join the program. Verification is carried out to ensure that the requirements have been met by the consumer before the consumer is able to take part in the program by capturing of the merchant code or presenting the primary consumer code to the merchant for capturing (517). In this case, the merchant code is only opened to consumers who are eligible to participate in the program. The secondary code which serves as a mobile card, vouchers, coupons or ticket is downloaded to the mobile consumer node (518) once the consumer accepts to disclose his information to the merchant. Information like profile, preference and payment source of the consumer to be disclosed to the merchant could be selected. Information of the consumer as a participant of the program will then be updated to the server while the merchant receives the information. Rejected applications are recorded in the server and shown in the merchant statistics records (516). This entire process is summarized in FIG. 5.

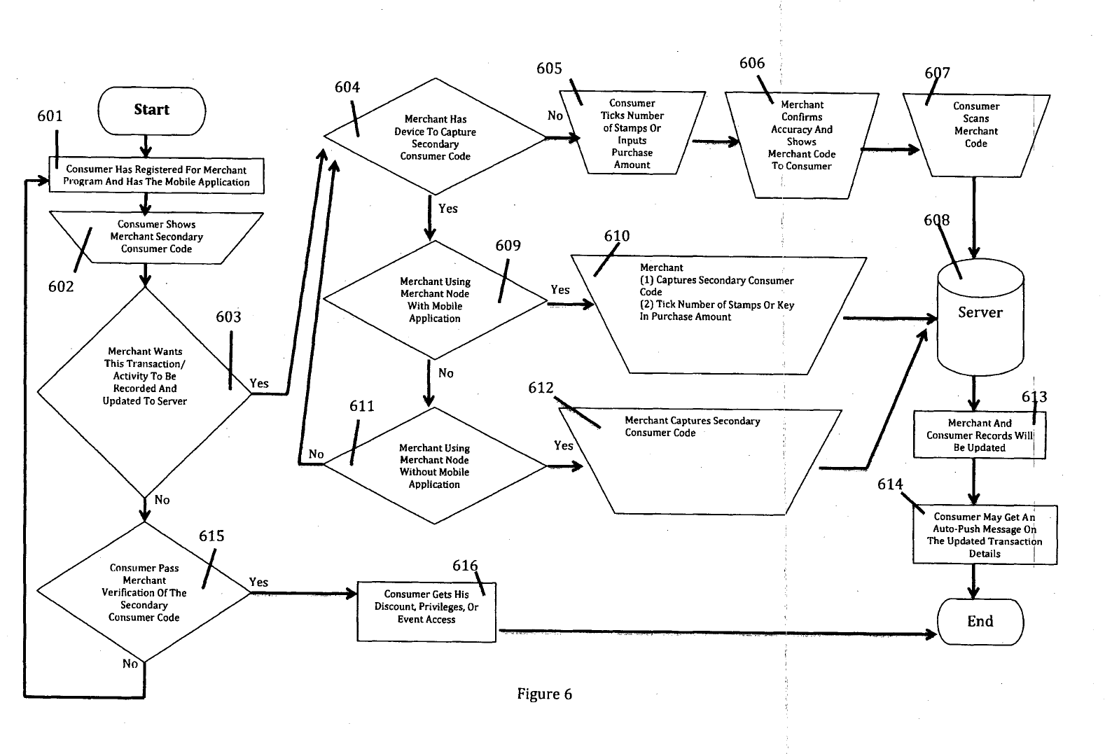

FIG. 6 illustrates the process of how consumers can use and participate in the merchant programs of this system. The consumer presents the secondary consumer code (602) to the merchant that is downloaded to his mobile consumer node upon enrolling in the merchant program (601). The merchant carries out actions depending on the type of program that the consumer is enrolled in, such as giving instant discount if it is a discount program, issuing and allowing consumers to redeem downloaded coupons or vouchers if it is a coupon or voucher program, providing access to an event if it is a ticketing program or accumulating points if it is a point reward program. In a situation where merchant nodes are not available, this could be achieved by ticking the number of stamps or inputting the purchase amount using the consumer mobile application (605) and presenting it to the merchant for verification (606). The merchant then shows his merchant code for the consumer to capture with the use of the mobile consumer node of the consumer (607). The consumer activity will be updated to the server (608).

Another option for consumers to receive their privileges, rewards, discounts, coupons, vouchers, purchased tickets or services is through capturing of the secondary consumer code by the merchant with the use of the merchant mobile application (609). In this case, the merchant device is a portable device and compatible to be implemented with the merchant mobile application like the mobile consumer node which could be a smartphone, tablet or PDA. The merchant captures the secondary consumer code using his portable merchant node and keys in the purchase amount of the consumer or record the number of stamps through ticking via the merchant mobile application (610). Alternatively, the merchant could capture the secondary consumer code with the use of a merchant node that is accessible to the online platform through the web browser (611). The merchant node is usually located at the point of sale. In a preferred embodiment, the records related to the same merchant program such as the rewards, privileges, discount, stamps or points accumulated, coupons or vouchers transactions, or details events participated are automatically captured and saved into the server when the secondary customer code is read by the merchant device (612). Once the merchant code or secondary customer code is captured and its information pertaining to the new consumer activity is saved and updated (613) to the server (608), the consumer could receive an automatically sent message on the updated details of the consumer activity (614). It is also possible that the consumer receives his discount, privileges, rewards, coupons, vouchers or event access (616) without having his secondary consumer code captured after presenting to the merchant to verify the validity of the secondary consumer code (615).

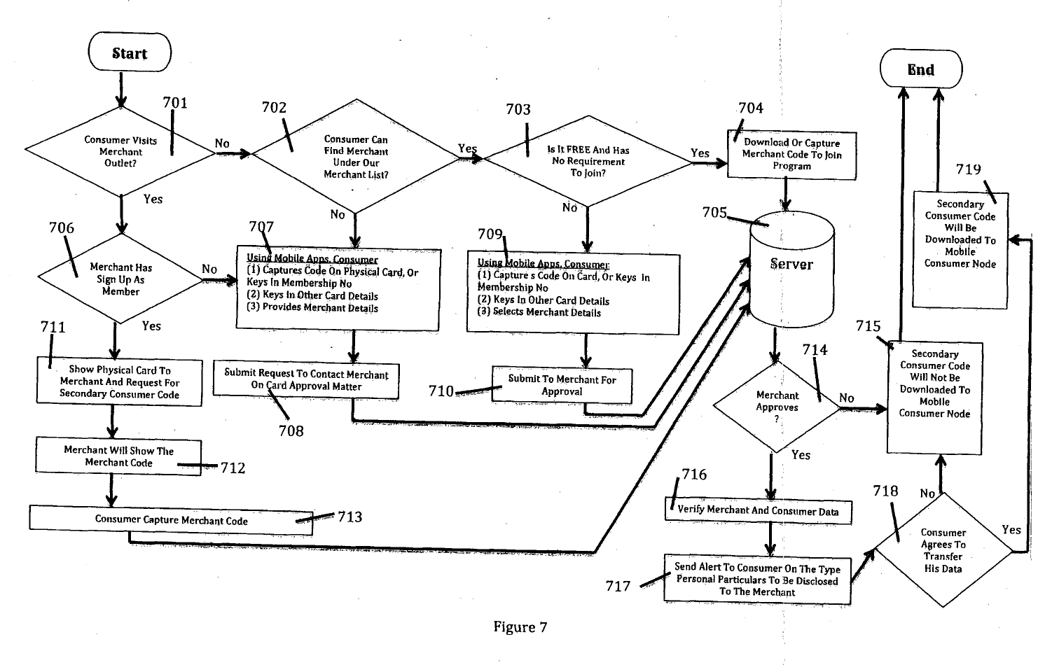

Merchants could continue their on-going merchant programs which have been launched during the time where physical cards are the only identification means by converting the consumers' existing physical cards to mobile cards in the form of secondary consumer codes. This could be done via several ways described in FIG. 7. One of them is through capturing of the merchant code by the consumer (713) upon presenting the existing physical card (711) where the information encrypted in the merchant code is saved into the server (705). Another way which could be done remotely without having to visit the merchant's outlet is by capturing the code on the physical card or keying in the card number and details as well as providing details of the merchant via the mobile application (707, 709). The merchant will be contacted regarding the mobile card approval (708) upon receiving the details which are stored in the server (705) if the merchant is not listed under the merchant list in the online platform. Else, if the merchant is on the merchant list, the details will be submitted directly to the merchant (710).

Details of the merchant and consumers are verified (716) when the merchant approves (714) the change of cards from physical to digital. The consumer might receive alert regarding the type of personal information such as profile, preference and payment source (717) that he allows to be disclosed to the merchant (718). Upon acceptance of the consumer information by the merchant, the secondary consumer code will be downloaded to the mobile consumer node (719).

The system allows issuing of any one or combination of coupons or vouchers to be conducted easily just by capturing the merchant codes by consumer or capturing the primary consumer code by the merchant in which coupons or vouchers are downloadable to the mobile consumer node. While purchasing of the coupons or vouchers could be done from the online platform, coupons or vouchers could also be given to consumers for free depending on the program scheme set by the merchant. With controlling modules to regulate and verify consumers who are eligible of downloading the coupons or vouchers, the number of coupons or vouchers downloads can be restricted for each consumer. Downloaded coupons or vouchers are stored in the mobile consumer node and will be removed upon expiry. By using electronic coupons or vouchers through downloading, conventional coupon or voucher issuing methods such as distribution of paper coupons or voucher by hand or by printing from emails or websites can be omitted. Such paperless system is not only beneficial to the environment but also provides tracking of the coupon or voucher as well as prevents uncontrollable printing of coupons or vouchers that could only be used once. A same approach is applied to the ticket purchasing, lucky draw tickets issuing, and subscription programs where tickets and subscribed products such as newsletters are downloadable to the mobile consumer node. Mobile cards that are means to represent the identity of the consumers or for use in other purposes such as money transaction could also be downloaded to the mobile consumer node.

Interaction between the merchant and consumer could be enhanced through the present invention. The merchant could send any one or combination of alerts or replies to the consumers by any one or combination of instant messaging, email, SMS, MMS and social media posting. Push technology could be implemented to the system in which push notifications could be sent to consumers to receive alerts from the merchants. The alerts are any one or combination of promotion, news, confirmation, reminders, feedback replies or event alerts. In addition to that, consumers are able to conveniently provide feedback or rate the merchants' services by capturing the merchant code which could be a feedback or voting merchant program code. Else, feedback could also be done via the online platform through the mobile application or web browser. Feedback and ratings are instantly sent to the merchant.

Although the description above contains many specifications, it is understood that the embodiments of the preferred form are not to be regarded as a departure from the invention and it may be modified within the scope of the appended claims.

1.-27. (canceled)

28. A consolidated merchant programs system, comprising:
at least one merchant node operated by a merchant;
at least one mobile consumer node operated by a consumer;
a server having a user interface to provide an online platform for the merchant to launch one or more merchant programs through the merchant node;
a merchant code generated by the server for each of the merchant program;
a primary consumer code generated by the server and assigned to the consumer as an identity of the consumer;
wherein the primary consumer code is downloaded to the consumer node upon signing up for a consumer account on the system; and
a secondary consumer code containing data of the merchant program and the identity of the consumer;
wherein the secondary consumer code is generated upon the merchant node capturing the primary consumer code and sending the primary consumer code together with the merchant code to the server for processing to generate the secondary consumer code or upon the consumer node capturing the merchant code and sending the merchant code together with the primary consumer code to the server for processing to generate the secondary consumer code;
wherein the secondary consumer code is downloaded to the consumer node upon approval of enrollment of the consumer in the merchant program for participating in a consumer activity of the merchant program.

29. The consolidated merchant programs system according to claim 28, wherein the primary consumer code, secondary consumer code and merchant codes are 2D barcodes.

30. The consolidated merchant programs system according to claim 28, wherein the consumer activity is participated through capturing the secondary consumer code by the merchant node and sending the secondary consumer code and merchant code to the server by the merchant node for processing or through capturing the merchant code by the consumer node and sending the merchant code and secondary consumer code to the server by the consumer node for processing.

31. The consolidated merchant program system according to claim 30, wherein the merchant node is configured to specify name of the merchant program that the consumer intended to enroll prior to or after capturing the primary consumer code.

32. The consolidated merchant programs system according to claim 28, wherein the merchant program comprises any one or combination of a discount program, stamp card program, points reward program, rebate program, reward redemption program, membership enrollment program, membership renewal program, lucky draw program, ticketing program, coupon program, voucher program, promotion program, subscription program, activity registration program, voting program and feedback program.

33. The consolidated merchant programs according to claim 28, wherein the platform is accessible through a mobile application and/or a web browser.

34. The consolidated merchant programs system according to claim 33, wherein the mobile application is incorporated with code capturing and reading functions.

35. The consolidated merchant programs system according to claim 28, wherein the mobile consumer node is equipped with any one, or a combination of, a camera, scanner or sensor for capturing the merchant code.

36. The consolidated merchant programs system according to claim 28, wherein the merchant node is implemented with a program with code capturing and reading functions.

37. The consolidated merchant programs system according to claim 28, wherein the merchant node is equipped with any one, or a combination of, a camera, scanner or sensor for capturing the consumer code.

38. The consolidated merchant programs system according to claim 28, wherein the mobile consumer node and/or merchant node is equipped with a location detector module for detecting location of the code capturing.

39. A method of enrolling a consumer in a merchant program through a consolidated merchant programs system, comprising the steps of:
providing an online platform as a user interface communicating with a server;
providing a consumer capable of communicating with the server by a mobile
consumer node storing a primary consumer code based on an identity of the consumer;
launching the merchant program by a merchant through a merchant node via the online platform;
generating a merchant code for each merchant program;
publishing the merchant code and information of the merchant program digitally and/or physically; and
enrolling the consumer in the merchant program either through using the merchant node to capture the primary consumer code and sending the primary consumer code together with the merchant code to the server for processing to generate a secondary consumer code or through using the consumer node to capture the merchant code and send the merchant code together with the primary consumer code to the server for processing to generate the secondary consumer code;
wherein the secondary consumer code generated contains data of the identity of the consumer and merchant program enrolled;
wherein the secondary consumer code is downloaded to the consumer node upon enrolling in the merchant program.

40. The method according to claim 29, wherein the primary consumer code, secondary consumer code and merchant code are 2D barcodes.

41. The method according to claim 29, further comprising the steps of participating in a consumer activity for receiving any one or combination of benefits or services of the merchant program either through capturing the secondary consumer code by the merchant node and sending the secondary consumer code and merchant code by the merchant node to the server for processing or through capturing the merchant code by the consumer node and sending the merchant code and secondary consumer code by the consumer node to the server for processing.

42. The method according to claim 29, further comprising the step of signing up for a merchant account by the merchant through the online platform before launching the merchant program.

43. The method according to claim 29, further comprising the step of signing up for a consumer account by the consumer through the online platform before receiving the primary consumer code.

44. The method according to claim 29, further comprising the step of saving merchant activities carried out by the merchant to administer the merchant programs to the server.

45. The method according to claim 29, wherein the codes are captured by scanning the codes with the use of a scanner, capturing the image with the use of a camera or transmitting data of the codes through radio frequency with the use of a sensor.

46. The method according to claim 41, wherein the benefits comprising any one or combination of privileges, discount, cash rebate, coupons, vouchers and rewards.

47. The method according to claim 41, wherein the services comprising any one or combination of stamps collection, points collection, membership enrollment, membership renewal, lucky draw, tickets purchasing, vouchers purchasing or redemption, coupons purchasing or redemption, subscription, activity registration, voting and giving feedback.

48. The method according to claim 46, wherein any one, or a combination of, the coupon, voucher, mobile card or ticket are downloaded to the consumer node.

49. The method according to claim 47, wherein any one, or a combination of, the coupon, voucher, mobile card or ticket are downloaded to the consumer node.

50. The method according to claim 39, wherein the information of the merchant program is published on the online platform.

51. The method according to claim 39, wherein the merchant receives consumer information through the platform when the consumer enrolls in the merchant program.

52. The method according to claim 39, wherein the consumer information to be disclosed to the merchant upon enrolling in the merchant program is selectable.

53. The method according to any one of claim 51, wherein the consumer information is any one or combination of a profile, preference and payment source of the consumer.

54. The method according to any one of claim 52, wherein the consumer information is any one or combination of a profile, preference and payment source of the consumer.

55. The method according to claim 29, wherein the merchant sends alerts and/or replies to the consumer by any one or combination of instant messaging, email, MS, MMS, push notification and social media posting.

56. The method according to claim 55, wherein the alerts are any one, or a combination of. promotion, news, confirmation, reminders, feedback replies or event alerts.

57. The method according to claim 29, wherein the codes are readable through Near Field Communication.
